(19) United States
(12) Patent Application Publication
(10) Pub. No.: US 2013/0137022 A1
(43) Pub. Date: May 30, 2013

(54) IMAGE BEARING MEMBER AND IMAGE FORMING APPARATUS AND PROCESS CARTRIDGE USING THE SAME

(71) Applicants: Naohiro TODA, Kanagawa (JP); Takafumi IWAMOTO, Shizuoka (JP)

(72) Inventors: Naohiro TODA, Kanagawa (JP); Takafumi IWAMOTO, Shizuoka (JP)

(21) Appl. No.: 13/672,330

(22) Filed: Nov. 8, 2012

(30) Foreign Application Priority Data
Nov. 24, 2011 (JP) 2011-256376

(51) Int. Cl. G03G 15/00; G03G 21/18

(52) U.S. Cl. 430/56; 399/111; 399/159

(57) ABSTRACT

An image bearing member includes a substrate, a photosensitive layer overlying the substrate, and a surface protective layer overlying the photosensitive layer and having a surface comprising multiple concave structures with a maximum diameter of from 1 μm to 3 μm and a maximum depth of from 10 nm to 50 nm. Any one of the concave structures has at least one other concave structure within 3 μm thereof.

### CROSS-REFERENCE TO RELATED APPLICATION

This patent application is based on and claims priority pursuant to 35 U.S.C. §119 to Japanese Patent Application No. 2011-256376, filed on Nov. 24, 2011, in the Japan Patent Office, the entire disclosure of which is hereby incorporated by reference herein.

### BACKGROUND OF THE INVENTION

1. Field of the Invention

The present invention relates to an image bearing member, and to an image forming apparatus and a process cartridge that use the image bearing member.

2. Description of the Background Art

Organic photoconductors (photoreceptors) have come to be used in place of inorganic photoconductors in photocopiers, facsimile machines, laser printers, and multi-functional devices thereof because they have many advantages. Specific advantages for this supersession include, for example, (1) good optical characteristics, for example, a broad range of optical absorption wavelengths and a large amount of light absorption; (2) superior electrical characteristics, for example, high sensitivity and stable chargeability; (3) a wide selection of materials; (4) ease of manufacturing; (5) inexpensive cost; and (6) non-toxicity.

In addition, in an attempt to manufacture a more compact image forming apparatus, the diameter of the photoreceptor is constantly being reduced. With higher speed performance and maintenance-free machines, an image bearing member having excellent durability is essential. From this point of view, an organic photoconductor is soft in general and wears out easily because the surface layer thereof is mainly made of a low molecular weight charge transport material and an inert polymer, which tend to abrade easily with repeated use due to mechanical stress from the developing system or cleaning system. In addition, it is necessary to use harder rubber for the cleaning blade and increase the contact pressure between the cleaning blade and the image bearing member to improve the cleaning property of the image bearing member in order to handle the smaller toner particles required for production of quality images. This is another factor accelerating abrasion of the image bearing member. Such abrasion of the image bearing member causes deterioration of the electric characteristics thereof, resulting in production of defective images with uneven image density and with background fouling. Furthermore, localized damage to the image bearing member due to abrasion causes production of defective images having streaks ascribable to poor cleaning of the image bearing member.

Therefore, it is essential to reduce abrasion of the organic photoconductors in order to improve their durability. At the same time, toner having improved releasability is required for better cleaning of the image bearing member. In particular, in a case in which toner components are attached to the surface of the image bearing member as the extent of abrasion is reduced, the surface is not scraped, thereby making it difficult to remove the attached toner components. This leads to production of defective images. Therefore, an organic photoconductor having a good surface properties is necessary, in order to provide a good combination of abrasion resistance and toner releasability.

As methods and devices to have a good combination of the abrasion resistance and the releasing property of the surface of the image bearing member, for example, (1): Japanese Patent Publication No. (JP- -B1) 3938210 (WO 2005-093520-A1) describes a method of achieving a high cleaning property by having multiple concavo portions having particular dimple forms on the surface of an image bearing member; (2): JP-4208367-B1 (JP-2001-166510-A) describes a surface protective layer that contains a compound formed by polymerizing an anti-oxidant, an anti-deterioration agent, a light-shielding agent, or a lubricant which has a curable chain-reaction polymerizable functional group and a silicon atom; (3): JP-4160512-B1 (JP-2005-208112-A) describes a cross-linked resin layer as the surface layer, in which a copolymer having polyorganosiloxane as a component is dispersed and which is formed by curing a tri- or higher radical polymerizable monomer with no charge transport structure and a mono-functional radical polymerizable compound having a charge transport structure; (4): Japanese Patent Application Publication No. (JP- -A) H06-95413 describes the uppermost surface layer of an image bearing member which has fluorine resin particulates in an amount of 10% by weight or more in order that the contact angle of the uppermost surface with pure water is 100° or greater; (5): JP-4214655-B1 (JP-2001-272802-A) describes a photosensitive layer having a polyester resin having a particular structure unit and a wax having 20 to 150 carbon atoms formed by an ester bonding of a carboxylic acid and an alcohol; (6): JP-2007-193309-A describes an uppermost surface layer having at least one of a particulate polyarylate resin, a polytrifluoroethylene, a perfluoro polyether, or a mixture thereof; (7): JP-2009-104146-A describes a surface layer having a polymer having a particular repeating structure unit formed of an acrylate monomer, a methacrylate monomer, etc. having at least one of a fluoroalkyl group and a fluoroalkylene group; (8) JP-2007-025676-A describes a surface layer having a cross-linked polysiloxane composition containing a perfluoro polyether portion; and (9): JP-2003-066642-A describes a surface protective layer formed by application and curing of a composition mainly containing particular surface-treated silica particles and an optical polymerization initiator, on which a chemical absorption layer is provided via a siloxane bonding. However, these are not satisfactory in terms of the mechanical strength, the releasing property, and the stability of image production over a long period of time required for an organic photoconductor.

### SUMMARY OF THE INVENTION

In view of the foregoing, the present invention provides an image bearing member having a substrate, a photosensitive layer overlying the substrate, and a surface protective layer overlying the photosensitive layer and having a surface containing multiple concave structures with a maximum diameter of from 1 μm to 3 μm and a maximum depth of from 10 nm to 50 nm, any one of the concave structures having at least one other concave structure within 3 μm thereof.

As another aspect of the present invention, a process cartridge is provided which includes the image bearing member mentioned above and at least one device selected from the group consisting of a charger, a development device, a transfer device, and a discharging device, wherein the process cartridge is detachably attachable to an image forming apparatus.

As another aspect of the present invention, an image forming apparatus is provided which includes the image bearing member mentioned above, a charger to charge the surface of the image bearing member, an irradiator to irradiate the surface of the image bearing member with beams of light to form a latent electrostatic image on the surface of the image bearing member, a development device to develop the latent electrostatic image with toner to form a visual image, a transfer device to transfer the visual image onto a recording medium; and a fixing device to fix the visual image on the recording medium.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1A is a schematic cross section illustrating an example of a typical surface concave structure and FIG. 1B is a schematic cross section illustrating an example of a fine concave structure of the present disclosure;

FIG. 2A is a schematic plain view illustrating an example of a typical surface concave structure and FIG. 2B is a schematic plain view illustrating an example of a fine concave structure of the present disclosure;

FIG. 3 is an image of an example of the fine surface concave structure taken by an electron microscope;

FIG. 4 is a diagram illustrating the maximum diameter of the concave portion and the closest concave distance between the concave portions;

FIG. 5 is a diagram illustrating the maximum depth of the concave structure;

FIG. 6 is a schematic diagram illustrating another example of an image bearing member of the present disclosure;

FIG. 7 is a schematic diagram illustrating another example of an image bearing member of the present disclosure;

FIG. 8 is a schematic diagram illustrating an example of an image forming apparatus of the present disclosure; and

FIG. 9 is a schematic diagram illustrating an example of a process cartridge of the present disclosure for use in an image forming apparatus.

### DETAILED DESCRIPTION OF THE INVENTION

The image bearing member of the present disclosure has multiple concave structures (portions) on the surface of the surface protective layer with a maximum diameter of the concave structure of from 1 μm to 3 μm and a maximum depth of 10 nm to 50 nm while any of the concave structures has at least one other concave structure within 3 μm. Therefore, the image bearing member has a high abrasion resistance and a high releasability.

JP-3938210-B (W005-93520) mentioned above describes a method of improving the removability of toner on the surface of an image bearing member by providing a concave surface structure having dimple forms with a maximum diameter of from 1 μm to 50 μm, a depth of 0.1 μm or greater, and a volume of 1 μm³ or greater while the number of the concave portions is from 5 to 50 per 100 μm² of the surface layer of the image bearing member to decrease the contact area between the surface of the image bearing member and the cleaning blade, thereby improving the slipping property therebetween. The present disclosure provides a finer concave structure in order to be able to improve the releasability of toner particles from the surface of the image bearing member and in particular is suitable for an image forming apparatus having no cleaner such as a cleaning blade.

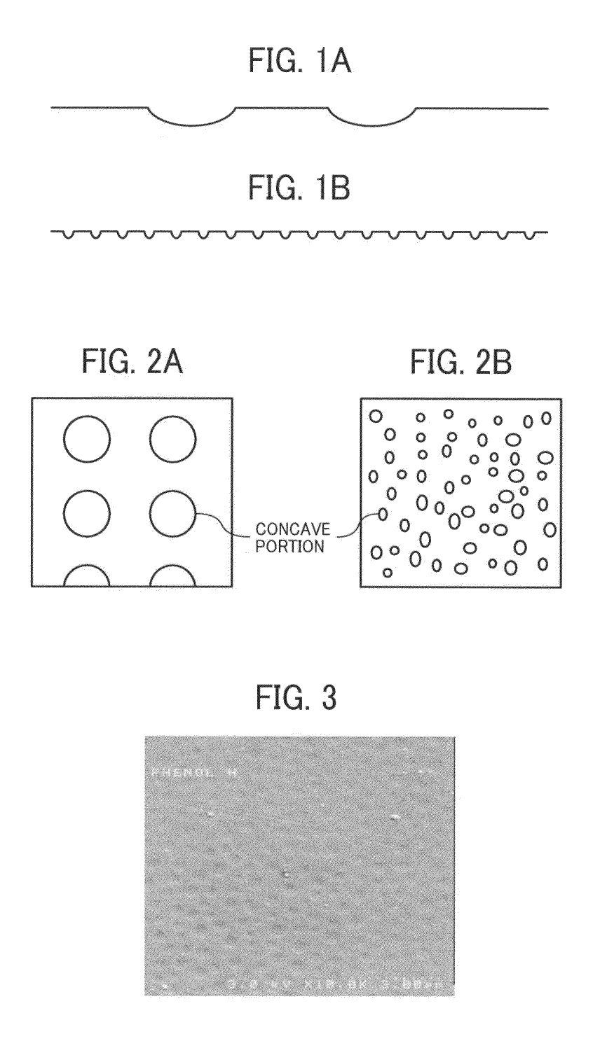

In the present disclosure, providing a fine concave structure in comparison with toner particles having about 5 μm is found to improve the releasability between the toner particles and the surface of the image bearing member. The inferred mechanism is that the contact area of the toner and the image bearing member decreases, thereby reducing the attachment between the surface of the image bearing member and the toner particles. In particular, the concave structure having a maximum diameter within a range of from 1 μm to 3 μm is suitable to reduce the contact area between the toner and the image bearing member, which leads to improvement of the releasability of the toner on the surface of the image bearing member. In addition, when the depth of the concave portion is from 10 nm to 50 nm, different from typical concave portions, silica particles serving as external additives tend to be prevented from being buried in or attached to the dimple of the concave portion. FIGS. 1A, 1B, 2A, and 2B illustrate the difference between the typical structure and the structure of the present disclosure on the surface of an image bearing member. FIG. 1A and FIG. 2A are diagrams illustrating the typical concave structure and FIGS. 1B and 2B, the present disclosure. FIG. 3 is an image of an example of the fine surface concave structure taken by an electron microscope.

Although the mechanism of forming a surface form having fine concave structure is not clear, it is possible to form such a layer in particular by using a resol type phenolic resin under particulate conditions. It is inferred that such a layer is formed by contraction of the surface and dehydration in an extremely short time due to contraction reaction during heating and curing.

In the present disclosure, it is possible to provide an image bearing member that can continue producing quality images over an extended period of time by forming a curing type surface protective layer having a fine concave structure to improve the abrasion resistance and the releasability.

### Image Bearing Member

The image bearing member of the present disclosure includes a substrate on which a photosensitive layer and a surface protective layer are provided with other optional layers.

The image bearing member of the present disclosure can be widely applied to, for example, a laser printer, a direct digital plate maker, a full color photocopier employing direct or indirect multi-color electrophotography, a full color laser printer, a CRT printer, an LED printer, a liquid crystal printer, a laser plate making, and a full color plain paper facsimile.

### Surface Protective Layer

The surface of the surface protective layer has multiple concave structures (portions) with a maximum diameter of the concave structure of from 1 μm to 3 μm and a maximum depth of 10 nm to 50 nm while any of the concave structures has at least one other concave structure within 3 μm thereof.

The form can be measured by an intermolecular force microscope at any arbitrary three places of 10 μm² to obtain an average thereof.

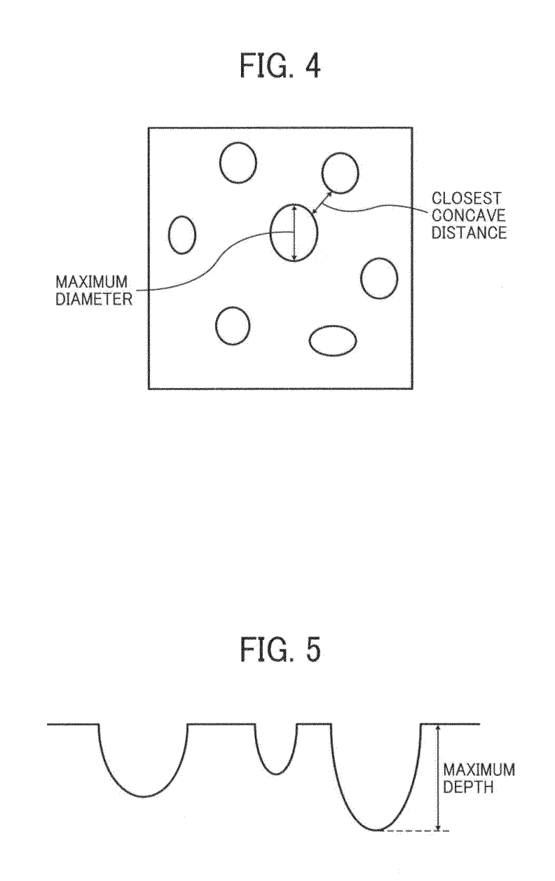

As illustrated in FIG. 4, the maximum diameter means the longest major diameter among major diameters of measurable individual concave portions when observing the concave portions present on the surface of the image bearing member. Furthermore, the distance between an arbitrary concave structure and the concave structure closest thereto is the minimum distance of the smooth surface portion and is represented by the closest concave distance. Moreover, in the form measuring about 10 μm², the maximum depth is defined as the deepest depth among the depths from the reference surfaces of individual concave portions as illustrated in FIG. 5, where the reference surface is defined as the height average of the smooth portion.

The surface protective layer is formed by conducting condensation reaction of a resol type phenolic resin, which is used in the present disclosure, during layer forming under conditions described later. By the concave structure smaller than the toner particles, the releasability of the toner ameliorates. In addition, the phenolic structure in the resol type phenolic resin molecules has a high hardness and an excellent abrasion resistance so that the toner maintains a high releasability over an extended period of time, resulting in provision of an image bearing member that continue producing quality images.

In the present disclosure, any known resol type phenolic resin can be suitably used. A specific structure example thereof is the resin represented by the following Chemical Structure 1, which forms a three dimensional cross-linking structure by heating. In particular, a number of phenolic structures in molecules have a high hardness, thereby improving the mechanical strength to contribute to forming an excellent surface protective layer.

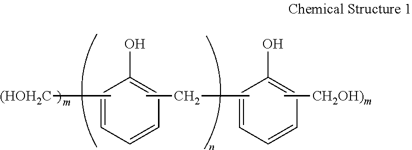

In the Chemical Structure 1, m represents an integer of from 1 to 2 and n represents an integer of from 1 to 12.

Specific examples of the resol type phenolic resins include, but are not limited to, PHENOLITE® TD-2547 and PHENOLITE® J-325 (manufactured by DIC CORPORATION), BLS-356B (manufactured by SHOWA DENKO K.K.), and SUMILITE® PR-50404 and PR-51206 (manufactured by SUMITOMO BAKELITE CO., LTD.).

The resol-type phenolic resin is applied as the surface protective layer of an image bearing member in a form of paint using an alcohol-based solvent such as methanol, ethanol, propanol, and butanol or used by diluting a solid portion of the paint to be 10% by weight to 25% by weight so that the formed surface protective layer contains a large amount of the solvent. Therefore, the mobility of the phenolic resins increases, which makes it easy to form a cross-linking structure and a concave structure having a suitable depth.

The resol-type phenolic resin is applied to the photosensitive layer to form a surface protective layer having a number of concave portions on its surface by curing reaction by heating. The heating temperature is from 140° C. to 180° C. and preferably from 150° C. to 170° C.

The thickness of the surface protective layer is preferably from 2 μm to 5 μm. When the surface protective layer is too thin, the solvent in the layer tends to evaporate, which results in cross-linking reaction in a small amount of the solvent in the surface protective layer, thereby making it difficult to obtain a surface having concave portions. When the surface protective layer is too thick, the reproducibility of images tends to deteriorate because of deterioration of the charge transport property.

### Curing Agent

A curing agent can be used in combination to conduct the curing reaction efficiently while forming a layer of the resol type phenolic resin by heating.

Specific examples of the curing agent include, but are not limited to, inorganic acids such as hydrochloric acid, sulfuric acid, and phospholic acid and organic acids such as formic acid, acetic acid, lactic acid, paratoluene sulphonic acid, phenolic sulphonic acid, and xylene sulphonic acid.

The content of the curing agent is preferably from 0.1 parts by weight to 10 parts by weight and more preferably from 0.5 parts by weight to 5 parts by weight based on 100 parts by weight of the phenolic resin.

### Filler

The surface protective layer contains the resol type phenolic resin and the surface thereof has multiple concave portions with a maximum diameter of from 1 μm to 3 μm and a maximum depth of from 10 nm to 50 nm while any of the concave structures has at least one other concave portion within 3 μm thereof. In addition, it is preferable to contain fillers to improve the abrasion resistance. Both inorganic fillers and organic fillers can be suitably used. Specific examples of the organic fillers include, but are not limited to, powder of a fluorine resin such as polytetra fluoroethylene, silicone resin powder, and a-carbon powder. Specific examples of the inorganic fillers include, but are not limited to, powders of metals such as copper, tin, aluminum, and indium; metal oxides such as silica, tin oxide, zinc oxide, titanium oxide, alumina, zirconium oxide, indium oxide, antimony oxide, bismuth oxide, calcium oxide, tin oxide doped with antimony, and indium oxide doped with tin; fluorinated metals such as fluorinated tin, fluorinated calcium, and fluorinated aluminum; potassium titanate; and arsenic nitride. Among these, using inorganic fillers is advantageous with regard to improvement in the abrasion resistance in terms of the hardness of filler.

In addition, the average primary particle diameter of the filler is preferably from 0.01 μm to 0.5 μm in terms of the optical transmittance and abrasion resistance of the surface protective layer. When the average primary diameter of the filler is too small, the dispersion stability tends to deteriorate, which prevents sufficient demonstration of improvement of the abrasion resistance. A filer having an average primary diameter that is excessively large tends to accelerate the sedimentation of the filler in the liquid dispersion of the surface protective layer and cause filming of the toner.

The abrasion resistance of the surface protective layer is improved as the content of the filler in the surface protective layer increases. However, when the content of the filler is too high, the residual voltage tends to rise and the transmission factor of writing light for the surface protective layer tends to decrease, which may cause side-effects. In addition, the filler tends to expose to the surface, thereby forming convex portions, which prevents forming of the concave structures. Therefore, the content of the filler is preferably 50 parts by weight or less and more preferably 30 parts by weight or less.

Furthermore, these filler particulates can be subject to surface treatment with at least one surface treatment agent, which is preferable in terms of the dispersion property of the filler particulates. When the filler is poorly dispersed in the surface protective layer, the following problems may occur, which are: (1) the residual potential of the resultant image bearing member increases; (2) the transparency of the resultant protective layer decreases; (3) coating defects occur in the resultant surface protective layer; and, (4) the abrasion resistance of the surface protective layer deteriorates. These possibly develop into greater problems with regard to the durability of the resultant image bearing member and the quality of the images produced thereby.

Suitable surface treatment agents include known surface treatment agents. Among these, surface treatment agents that do not degrade the insulation property of the filler are preferred.

The content of the surface treatment agents mentioned above depends on the average primary particle diameter of the filler used but is preferably from 3 parts by weight to 30 parts by weight and more preferably from 5 parts by weight to 20 parts by weight based on 100 parts of the filler. Too little of the surface treatment agent tends not to improve the dispersion property of the filler. In contrast, too much of the surface treatment agent tends to significantly increase the residual potential of the image bearing member.

It is also suitable that the liquid application of the surface protective layer contains known charge transport materials to improve the charge transport property. However, an addition of a large amount of the charge transport material tends to demonstrate plasticizing effects, thereby decreasing the roughness of the surface of the surface protective layer during the curing reaction by heating. Therefore, it is preferable to select electroconductive fillers among the fillers specified above as the measures to improve the charge transport property.

Specific examples of the electroconductive filler include, but are not limited to, known fillers such as tin oxide, zinc oxide, and indium oxide.

With regard to the liquid application of the surface protective layer, it is possible to form a number of fine concave portions on the surface by applying a solution prepared by diluting the solid portion of the paint with a solvent to be 10% by weight to 25% by weight.

As described above, specific examples of the solvents that suitably dissolve the resol-type phenolic resin include, but are not limited to, alcohol-based solvents such as methanol, ethanol, propanol, and butanol.

It is suitable to add another solvent in which the surface of the photosensitive layer is highly soluble to improve the attachment between the photosensitive layer and the surface protective layer. Specific examples of such solvents to dissolve the photosensitive layer include, but are not limited to, ketone-based solvents such as acetone, methyl ethyl ketone, methyl isobutyl ketone, and cyclohexanone; ester-based solvents such as ethyl acetate and butyl acetate; ether-based solvents such as tetrahydrofuran, dioxane, and propyl ether; halogen-based solvents such as dichloromethane, dichloroethane, trichloroethane, and chlorobenzene; aromatic series-based solvents such as benzene, toluene, and xylene; and cellosolve-based solvents such as methyl cellosolve, ethyl cellosolve, and cellosolve acetate. These can be used alone or in combination.

A dip coating method, a spray coating method, a bead coating method, a ring coating method, etc., can be used when applying the liquid application of the protective surface layer.

In the present disclosure, after the application of the liquid application of the protective surface layer, thermal energy is applied from outside to cure the liquid application to form the surface protective layer. As described above, the heating temperature ranges from 140° C. to 180° C. and preferably from 150° C. to 170° C. to form a surface having a number of concave portions.

### Layer Structure of Image Bearing Member

The layer structure of the image bearing member of the present disclosure is described with reference to the accompanying drawings.

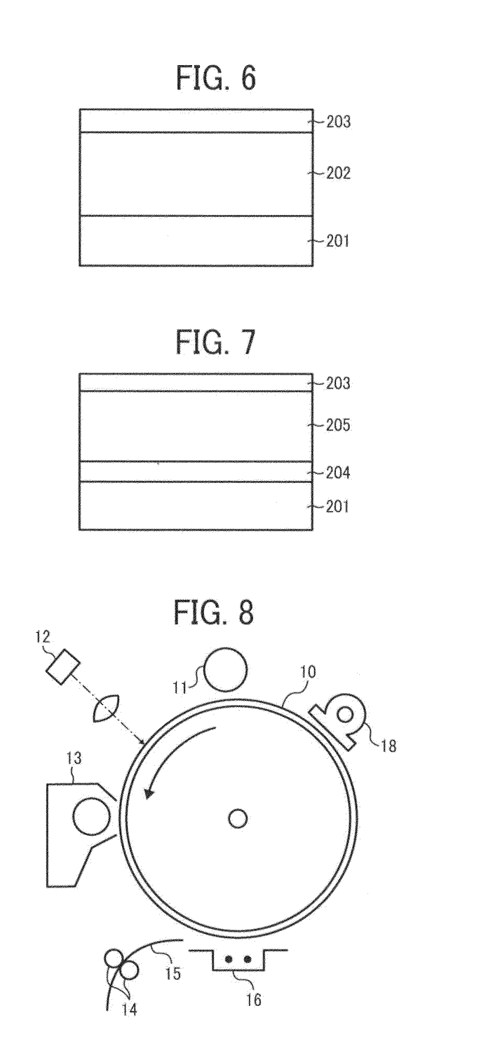

FIG. 6 is a cross section illustrating an example of an image bearing member of the present disclosure. On a substrate 201, there is provided a photosensitive layer 202 having both a charge generating feature and a charge transport feature simultaneously, on which a surface protective layer 203 is provided.

FIG. 7 is a cross section illustrating an example of an image bearing member of the present disclosure. On a substrate 201, a charge generating layer 204 having a charge generating feature and a charge transport layer 205 having a charge transport feature are laminated and moreover a surface protective layer 203 is provided on the charge transport layer 205.

### Substrate

There is no specific limit to the selection of the material for use in the substrate as long as the material is electroconductive and has a volume resistance of not greater than 1.0×10¹⁰ Ω·cm. For example, there can be used plastic or paper having a film form or cylindrical form covered with a metal such as aluminum, nickel, chrome, nichrome, copper, gold, silver, and platinum, or a metal oxide such as tin oxide and indium oxide by depositing or sputtering.

Also a board formed of aluminum, an aluminum alloy, nickel, and a stainless metal can be used. Further, a tube which is manufactured from the board mentioned above by a crafting technique such as extruding and extracting and surface-treatment such as cutting, super finishing and grinding is also usable. In addition, an endless nickel belt and an endless stainless belt described in JP-S52-36016-A can be used as the substrate.

A substrate formed by applying to the substrate mentioned above a liquid application in which electroconductive powder is dispersed in a suitable binder resin can be also suitably used as the substrate.

Specific examples of such electroconductive powder include, but are not limited to, carbon black, acetylene black, metal powder, such as powder of aluminum, nickel, iron, nichrome, copper, zinc, and silver, and metal oxide powder, such as electroconductive tin oxide powder and ITO powder. Specific examples of the binder resin used simultaneously include, but are not limited to, polystyrene resins, copolymers of styrene and acrylonitrile, copolymers of styrene and butadiene, copolymers of styrene and maleic anhydrate, polyesters resins, polyvinyl chloride resins, copolymers of a vinyl chloride and a vinyl acetate, polyvinyl acetate resins, polyvinylidene chloride resins, polyarylate resins, phenoxy resins, polycarbonate reins, cellulose acetate resins, ethyl cellulose resins, polyvinyl butyral resins, polyvinyl formal resins, polyvinyl toluene resins, poly-N-vinylcarbozole, acrylic resins, silicone resins, epoxy resins, melamine resins, urethane resins, phenolic resins, and alkyd resins. These can be used alone or in combination.

The electroconductive layer can be provided by applying to the substrate a liquid application in which these electroconductive powder and binder resin are dispersed in a solvent. Specific examples of the solvents include, but are not limited to, tetrahydrofuran, dichloromethane, methylethyl ketone, and toluene.

In addition, an electroconductive substrate formed by providing a heat contraction tube as an electroconductive layer on a suitable cylindrical substrate can be used as the substrate in the present disclosure. The heat contraction tube is formed of materials such as polyvinyl chloride, polypropylene, polyester, polystyrene, polyvinylidene chloride, polyethylene, chloride rubber, and TEFLON®, which contains the electroconductive powder mentioned above.

### Photosensitive Layer

The photosensitive layer takes a single layer structure or a laminate structure. The photosensitive layer having the laminate structure is formed of a charge generating layer having a charge generating feature and a charge transport layer having a charge transport feature. The photosensitive layer having the single layer structure is a layer having both a charge generating feature and a charge transport feature simultaneously.

The photosensitive layer of the laminate structure and the single layer structure is described below.

### Photosensitive Layer of Laminate Structure

### (1) Charge Generating Layer

The charge generating layer contains at least a charge generating material, a binder resin, and other optional materials.

Inorganic materials and organic materials can be used as the charge generating materials.

Specific examples of the inorganic materials include, but are not limited to, crystal selenium, amorphous-selenium, selenium-tellurium-halogen, selenium-arsenic compounds, and amorphous-silicon. With regard to the amorphous-silicon, those in which a dangling-bond is terminated with a hydrogen atom or a halogen atom and those in which boron atoms or phosphorous atoms are doped are preferably used.

There is no specific limit to the selection of the organic materials and any known organic material can be suitably used. Specific examples thereof include, but are not limited to, phthalocyanine pigments, for example, metal phthalocyanine and non-metal phthalocyanine; azulenium salt pigments; squaric acid methine pigments; azo pigments having a carbazole skeleton; azo pigments having a triphenylamine skeleton; azo pigments having a diphenylamine skeleton; azo pigments having a dibenzothiophene skeleton; azo pigments having a fluorenone skeleton; azo pigments having an oxadiazole skeleton; azo pigments having a bis-stilbene skeleton; azo pigments having a distilyloxadiazole skeleton; azo pigments having a distylylcarbazole skeleton; perylene pigments, anthraquinone or polycyclic quinone pigments; quinoneimine pigments; diphenylmethane and triphenylmethane pigments; benzoquinone and naphthoquinone pigments; cyanine and azomethine pigments, indigoid pigments, and bis-benzimidazole pigments. These can be used alone or in combination.

There is no specific limit to the selection of the binder resin. Specific examples of the binder resin include, but are not limited to, polyamide resins, polyurethane resins, epoxy resins, polyketone resins, polycarbonate resins, siliconee resins, acrylic resins, polyvinyl butyral resins, polyvinylformal resins, polyvinylketone resins, polystyrene resins, poly-N-vinylcarbazole resins, and polyacrylic amide resins. These can be used alone or in combination.

In addition to the binder resins specified above for the charge generating layer, charge transport polymers having a charge transport feature, for example, (1): polycarbonate resins, polyester resins, polyurethane resins, polyether resins, polysiloxane resins, or acrylic resins having an arylamine skeleton, a benzidine skeleton, a hydrazone skeleton, a carbazole skeleton, a stilbene skeleton, or a pyrazoline skeleton; and (2): polymers having a polysilane skeleton, can be also used.

Specific examples of (1): the former charge transport polymers include, but are not limited to, compounds specified in JP-H01-001728-A, JP-H01-009964-A, JP-H01-013061-A, JP-H01-019049-A, JP-H01-241559-A, JP-H04-011627-A, JP-H04-175337-A, JP-H04-183719-A, JP-H04-225014-A, JP-H04-230767-A, JP-H04-320420-A, JP-H05-232727-A, JP-H05-310904-A, JP-H06-234836-A, JP-H06-234837-A, JP-H06-234838-A, JP-H06-234839-A, JP-H06-234840-A, JP-H06-234840-A, JP-H06-234841-A, JP-H06-239049-A, JP-H06-236050-A, JP-H06-236051-A, JP-H06-295077-A, JP-H07-056374-A, JP-H08-176293-A, JP-H08-208820-A, JP-H08-211640-A, JP-H08-253568-A, JP-H08-269183-A, JP-H09-062019-A, JP-H09-043883-A, JP-H09-71642-A, JP-H09-87376-A, JP-H09-104746-A, JP-H09-110974-A, JP-H09-110974-A, JP-H09-110976-A, JP-H09-157378-A, JP-H09-221544-A, JP-H09-227669-A, JP-H09-221544-A, JP-H09-227669-A, JP-H09-235367-A, JP-H09-241369-A, JP-H09-268226-A, JP-H09-272735-A, JP-H09-272735-A, JP-H09-302084-A, JP-H09-302085-A, and JP-H09-328539-A.

Specific examples of (2): the latter polymers include, but are not limited to, polysilylene polymers described in JP-S63-285552-A, JP-H05-19497-A, JP-H05-70595-A, and JP-H10-73944-A.

The charge generating layer optionally contains a charge transport material having a low molecular weight.

The charge transport material having a low molecular weight is classified into a positive hole transport material and an electron transport material.

Specific examples of such electron transport materials include, but are not limited to, an electron acceptance material such as chloranil, bromanil, tetracyano ethylene, tetracyanoquino dimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, and diphenoquinone derivatives. These can be used alone or in combination.

Specific examples of such positive hole transport materials include, but are not limited to, oxazole derivatives, oxadiazole derivatives, imidazole derivatives, monoaryl amine derivatives, diaryl amine derivatives, triaryl amine derivatives, stilbene derivatives, a-phenyl stilbene derivatives, benzidine derivatives, diaryl methane derivatives, triaryl methane derivatives, 9-styryl anthracene derivatives, pyrazoline derivatives, divinyl benzene derivatives, hydrazone derivatives, indene derivatives, butadiene derivatives, pyrene derivatives, bisstilbene derivatives, enamine derivatives and other known materials. These can be used alone or in combination.

The charge generating layer can be formed by a vacuum thin layer forming method and a casting method from a solution dispersion system.

Specific examples of the vacuum thin layer forming method include, but are not limited to, a vacuum deposition method, a glow discharge decomposition method, an ion-plating method, a sputtering method, a reactive sputtering method, or a chemical vapor deposition (CVD) method.

In the casting method, the above-mentioned inorganic or organic charge generating material is dispersed with an optional binder resin in a solvent, for example, tetrahydrofuran, dioxane, dioxsolan, toluene, dichloromethane, monochlorobenzene, dichloroethane, cyclohexanone, cyclopentanone, anisole, xylene, methylethylketone, acetone, ethylacetate, butylacetate by using, for example, a ball mill, an attritor, a sand mill, or a bead mill. Thereafter, suitably diluted liquid dispersion is applied to the surface of the substrate to form the charge generating layer. Leveling agents such as dimethyl silicone oil and methylphenyl silicone oil can be optionally added. A dip coating method, a spray coating method, a bead coating method, a ring coating method, etc., is used for application of the liquid application.

There is no specific limit to the thickness of the charge generating layer. The charge generating layer preferably has a thickness of from 0.01 μm to 5 μm and more preferably from 0.015 μm to 2 μm.

### (2) Charge Transport Layer

The charge transport layer has a charge transport feature and contains at least a charge transport material and a binder resin.

The electron transport materials, the positive hole transport materials, and the charge transport polymers mentioned above in the description about the charge generating layer can be used as the charge transport material. Using a charge transport polymer is particularly suitable in terms of the reduction effect of the solubility of the layer provided below the surface protective layer when the surface protective layer is coated.

There is no specific limit to the binder resin. Specific examples of the binder resin include, but are not limited to, thermoplastic resins or thermocuring resins, for example, polystyrene, copolymers of styrene and acrylonitrile, copolymers of styrene and butadiene, copolymers of styrene and maleic anhydrate, polyesters, polyvinyl chlorides, copolymers of a vinyl chloride and a vinyl acetate, polyvinyl acetates, polyvinylidene chloride, polyarylate resins, phenoxy resins, polycarbonate reins, cellulose acetate resins, ethyl cellulose resins, polyvinyl butyral, polyvinyl formal, polyvinyl toluene, poly-N-vinylcarbozole, acrylic resin, silicone resins, epoxy resins, melamine resins, urethane resins, phenol resins, and alkyd resins. These can be used alone or in combination.

The content of the charge transport material is preferably from 20 parts by weight to 300 parts by weight and more preferably from 40 parts by weight to 150 parts by weight based on 100 parts by weight of the binder resin. The charge transport material can be used alone or in combination with the binder resin.

The same solvent specified for the charge generating layer can be used as the solvent for use in application of the charge transport layer. Among these, it is suitable to use a solvent that dissolves the charge transport material and the binder resin. These solvents can be used alone or in combination. In addition, the same method as in the case of the charge generating layer can be used to form the charge transport layer.

In addition, a plasticizing agent and/or a leveling agent can be added, if desired.

Known resin plasticizing agents, for example, dibutyl phthalate and dioctyl phthalate, can be used as the plasticizing agent. Its content is suitably 30 parts by weight or less based on 100 parts by weight of the binder resin.

Silicone oils such as dimethyl silicone oil, methyl phenyl silicone oil and a polymer or an oligomer having a perfluoroalkyl group in its side chain can be used as the leveling agent. The content thereof is suitably not greater than 1 part by weight based on the 100 parts of the binder resin.

The charge transport layer preferably has a thickness of from 5 μm to 40 μm and more preferably from 10 μm to 30 μm.

### Photosensitive Layer of Single Layer Structure

The photosensitive layer having a single layer structure has both the charge generating feature and the charge transport feature and the surface protective layer is provided on the photosensitive layer.

The photosensitive layer having a single layer structure can be formed by dissolving and/or dispersing a charge generating material having a charge generating feature, a charge transport material having a charge transport feature, and a binder resin in a suitable solvent followed by application and drying of the resultant liquid. In addition, a plasticizing agent and/or a leveling agent can be added, if desired. The same dispersion method of the charge generating material, the same charge generating material, the same charge transport material, the same plasticizing agent, and the same leveling agent as described for the charge generating layer and the charge transport layer can be used. As the binder resin, in addition to those specified for the charge transport layer, a mixture of the binder resin specified for the charge generating layer and the binder resin specified for the charge transport layer can be used. In addition, the charge transport polymer specified above can be also used and is advantageous in terms of preventing mingling of the composition of the photosensitive layer into the surface protective layer.

There is no specific limit to the thickness of the photosensitive layer. The photosensitive layer preferably has a thickness of from 5 μm to 30 μm and more preferably from 10 μm to 25 μm.

The content of the charge generating material contained in the photosensitive layer having a single layer structure is preferably from 1 part by weight to 30 parts by weight, the binder resin, preferably from 20 parts by weight to 80 parts by weight, and, the charge transport material, preferably from 10 parts by weight to 70 parts by weight based on the total amount of the photosensitive layer.

### Intermediate Layer

In the image bearing member of the present disclosure, an intermediate layer can be provided between the surface protective layer and the charge transport layer or the photosensitive layer having a single layer structure.

The intermediate layer prevents inhibition of the curing reaction caused by mingling of the photosensitive layer composition into the surface protective layer containing a radical polymerizable composition or occurrence of roughness of the surface protective layer. Also, it is possible to improve the attachability between the photosensitive layer and the surface protective layer.

Generally, the intermediate layer is mainly formed of a binder resin. Specific examples of the binder resins include, but are not limited to, polyamide, alcohol soluble nylon, hydro-soluble polyvinyl butyral, polyvinyl butyral, and polyvinyl alcohol.

There is no specific limit to the method of forming the intermediate layer and any known application method can be suitably used.

There is no specific limit to the thickness of the intermediate layer. The layer thickness thereof preferably ranges from 0.05 μm to 2 μm.

### Undercoating Layer

In the image bearing member of the present invention, an undercoating layer can be provided on the substrate.

The undercoating layer mainly contains a resin and other optional components. Considering that the surface protective layer, the photosensitive layer, the charge generating layer, or an intermediate layer is applied in liquid to such an undercoating layer, the resin is preferably not soluble in a known organic solvent.

Specific examples of such resins include, but are not limited to, hydrosoluble resins, such as polyvinyl alcohol, casein, and sodium polyacrylate, alcohol soluble resins such as copolymerized nylon and methoxymethylated nylon, and curing resins which form a three dimension network structure, such as polyurethane resins, melamine resins, phenolic resins, alkyd-melamine resins, and epoxy resins.

In addition, inclusion of fine powder pigments of metal oxides such as titanium oxide, silica, alumina, zirconium oxide, tin oxide, and indium oxide in the undercoating layer is suitable to prevent the occurrence of moire fringe and reduce the residual voltage.

The undercoating layer described above can be formed by a method using a solvent and a coating method as described for the photosensitive layer.

Silane coupling agents, titanium coupling agents, and chromium coupling agents can be used in the undercoating layer. Furthermore, the undercoating layer can be formed by anodizing Al₂O₃ or a vacuum thin-film forming method using an organic compound such as polyparaxylylene (parylene) or an inorganic compound such as SiO₂, SnO₂, TiO₂, ITO, and CeO₂. Any other known methods can be also used.

There is no specific limit to the thickness of the undercoating layer. The layer thickness thereof is preferably 5 μm or less.

Furthermore, in the present disclosure, an anti-oxidant can be added to each layer, i.e., the photosensitive layer having a single layer structure, the surface protective layer, the charge generating layer, the charge transport layer, the undercoating layer, the intermediate layer to improve the environment resistance, in particular, to prevent the degradation of the sensitivity and the rise in residual potential.

Specific examples of the anti-oxidants include, but are not limited to, phenolic-based compounds, paraphenylene diamines, hydroquinones, organic sulfur compounds, and organic phosphorus compounds. These can be used alone or in combination.

Specific examples of the phenolic-based compounds include, but are not limited to, 2,6-di-t-butyl-p-cresol, butylated hydroxyanisol, 2,6-di-t-butyl-4-ethylphenol, stearyl-β-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3, 3′-bis(4′-hydroxy-3′-t-butylphenyl)butyric acid]glycol ester, and tocopherols.

Specific examples of paraphenylene diamines include, but are not limited to, N-phenyl-N′-isopropyl-p-phenylene diamine, N,N′-di-sec-butyl-p-phenylene diamine, N-phenyl-N-sec-butyl-p-phenylene diamine, N,N′-di-isopropyl-p-phenylene diamine, and N,N′-dimetyl-N,N′-di-t-butyl-p-phenylene diamine.

Specific examples of hydroquinones include, but are not limited to, 2,5-di-t-octyl hydroquinone, 2,6-didodecyl hydroquinone, 2-dodecyl hydroquinone, 2-dodecyl-5-chloro hydroquinone, 2-t-octyl-5-methyl hydroquinone, and 2-(2-octadecenyl)-5-methyl hydroquinone.

Specific examples of the organic sulfur compounds include, but are not limited to, dilauryl-3,3′-thiodipropionate, distearyl-3,3□′-thiodipropionate, and ditetradecyl-3,3′-thiodipropionate.

Specific examples of the organic phosphorous compounds include, but are not limited to, triphenyl phosphine, tri(nonylphenyl)phosphine, tri(dinonylphenyl)phosphine, tricresyl phosphine, and tri(2,4-dibutylphenoxy)phosphine.

These compounds are known as anti-oxidants for rubber, plastic, and oils and those products are easily available from the market.

There is no specific limit to the content of the anti-oxidant. The content thereof is preferably from 0.01 parts by weight to 10 parts by weight based on the total content of the layer to which the anti-oxidant is attached.

### Image Forming Apparatus

The image forming apparatus of the present disclosure includes a (latent electrostatic) image bearing member, a development device, an irradiator, a transfer device, and a fixing device with optional devices such as a cleaning device, a discharging device, a recycling device, and a control device. A combination of the charger and the irradiator is also referred to as a latent electrostatic image forming device.

### Latent Electrostatic Image Forming Device

The latent electrostatic image forming device is a device to form a latent electrostatic image on the image bearing member.

The image forming apparatus uses the latent image bearing member of the present disclosure described above.

The latent electrostatic image is formed by, for example, uniformly charging the surface of the image bearing member followed by irradiation according to data information by the latent image forming device.

The latent electrostatic image forming device includes at least a charger which uniformly charges the surface of the image bearing member and an irradiator which irradiates the surface of the image bearing member according to obtained image information.

The surface of the image bearing member is charged by, for example, applying a voltage to the surface of the image bearing member by using the charger.

There is no specific limit to the selection of the charger and any known device can be suitably used. Specific examples thereof include, but are not limited to, a known contact type charger that includes an electroconductive or semi-conductive roller, brush, film, and a rubber blade, and a non-contact type charger using corona discharging such as corotron, and scorotron.

The charger may employ any form other than a roller, for example, a magnetic brush, and a fur brush and can be selected to the specification or form of an image forming apparatus. When a magnetic brush is used, the magnet brush uses a charging member formed of, for example, ferrite particles such as Zn—Cu ferrite. The magnetic brush is held by a non-magnetic electroconductive sleeve and a magnet roll is provided inside the non-magnetic electroconductive sleeve. When a brush is used, fur electroconductively-treated by carbon, copper sulfide, metal, or metal oxide is used as a fur brush material and rolled on or attached to metal or electroconductively treated metal core to make the charging device.

The charger is not limited to the contact type charger described above, but using such a contact type charger is preferable because an image forming apparatus using such a charger produces a less amount of ozone.

It is preferable to apply a direct voltage or a voltage obtained by superimposing an alternating voltage to a direct voltage to the surface of the latent image bearing member by the charger arranged in contact with or in the vicinity of the latent image bearing member.

It is preferable to apply a direct voltage or a voltage obtained by superimposing an alternating voltage to a direct voltage to the surface of the latent image bearing member by a charging roller arranged in the vicinity (non-contact) of the latent image bearing member via a gap tape.

The irradiation is conducted by irradiating the surface of the latent image bearing member according to data information using the irradiator.

Any irradiator that can irradiate the surface of the image bearing member charged by the charger according to the image information can be suitably used. Specific examples of such irradiators include, but are not limited to, a photocopying optical system, a rod lens array system, a laser optical system, and a liquid crystal shutter optical system.

As to the present disclosure, the rear side irradiation system in which an image bearing member is irradiated from the rear side can be also employed.

The development process is a process of forming a visual image by developing the latent electrostatic image with toner or a development agent.

The visual image is formed by, for example, developing the latent electrostatic image with toner or a development agent by the development device.

There is no specific limit to the development device as long as the development device develops a latent electrostatic image with the toner or the development agent and any known development device can be used. For example, a development device containing a development container which accommodates and applies the toner or the development agent to the latent electrostatic image in a contact or non-contact manner is suitably used.

The development unit may employ a dry or wet development system and a monochrome development unit or a full color development unit. For example, a development unit including a stirrer that abrasively stirs the toner or the development agent and the rotatable magnet roller is suitable.

In the development device, the toner and the carrier are mixed and stirred so that the toner is triboelectrically charged. The toner then stands on the surface of the rotatable magnet roller like a filament to form a magnet brush. Since the magnet roller is provided in the vicinity of the image bearing member, part of the toner forming the magnet brush borne on the surface of the magnet roller is transferred to the surface of the image bearing member by the electric attraction force. As a result, the latent electrostatic image is developed with the toner to form a visual toner image on the surface of the image bearing member.

Either one of a single component development agent and a two component development agent can be used as the development agent accommodated in the development unit. Both can be manufactured by a pulverization method or a polymerization method.

The external additives added to the surface of the toner are preferably inorganic particulates.

Specific examples of such inorganic particulates include, but are not limited to, silica, alumina, titania, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

The transfer device is to transfer the visual image to a recording medium directly or via an intermediate transfer medium to which the visual image is primarily transferred followed by secondary transfer to the recording medium. In a case in which at least two-color or preferably full color toner is used, it is preferable to use a transfer system having a primary transfer device to transfer the visual image to the intermediate transfer medium to form a complex transfer image and a secondary transfer device to transfer the complex transfer image to the recording medium.

There is no specific limit to the intermediate transfer medium and any known transfer medium can be suitably selected. For example, a transfer belt is preferably used.

The transfer device (the primary transfer device, the secondary transfer device) preferably has a transfer unit which peeling-charges the visual image formed on the image bearing member to the side of the recording medium. One or more transfer units may be used.

Specific examples of the transfer device include, but are not limited to, a corona transfer device using corona discharging, a transfer belt, a transfer roller, a pressure transfer roller, and an adhesive transfer device.

A typical example of the recording medium is plain paper but any paper to which a non-fixed image is transferred after development can be suitably used. PET base for an overhead projector can be also used.

The fixing process is a process in which the visual image transferred to the recording medium is fixed by a fixing device. Fixing can be performed every time each color toner image is transferred or at once for a multi-color laminated image.

Any fixing device can be suitably selected. Any known heating and pressure device can be used. A combination of a heating roller and a pressure roller and a combination of a heating roller, a pressure roller, and an endless belt can be used as the heating and pressure device.

The heating temperature by the heating and pressure device is preferably from 80° C. to 200° C.

In the fixing process for use in the present disclosure, for example, any known optical fixing device can be used together with or in place of the fixing device and the fixing process described above.

The discharger discharges the image bearing member by applying a discharging bias thereto.

There is no specific limit to the discharger and any known discharger that can apply a discharging bias to the image bearing member is suitable. For example, a discharging lamp may be used.

The cleaning device removes toner remaining on the image bearing member by using a cleaner.

There is no specific limit to the cleaner and any known cleaner can be selected as long as it can remove the toner remaining on the image bearing member. Preferred specific examples of such cleaners include, but are not limited to, a magnetic brush cleaner, an electroconductive brush cleaner, a magnetic roller cleaner, a blade cleaner, a brush cleaner, and a web cleaner. In addition, the image bearing member of the present disclosure uses the surface protective layer having excellent toner releasability, thereby reducing the residual toner amount after transferring the toner. Therefore, it can be applied to an image forming apparatus having no cleaner, which contributes to size reduction of the image bearing member.

The recycling process is a process in which the toner removed by the cleaning device described above is returned to the developing device for reuse.

There is no specific limit to the recycling device and any known conveying device, etc. can be used.

The control device controls the processes described above.

There is no specific limit to the control device as long as it can control the behavior of each device. Any control device can be suitably selected. For example, devices such as a sequencer and a computer can be used.

The image forming apparatus of the present disclosure uses an image bearing member (i.e., photoreceptor) having the surface protective layer for use in the present disclosure and conducts: charging, irradiation, and development followed by transferring the toner image to a transfer medium and fixing the toner image.

FIG. 8 is a schematic diagram illustrating an example of an image forming apparatus of the present disclosure. A charger 11 is used as a device to uniformly charge a photoreceptor (image bearing member) 10. Specific examples of the charger 11 include, but are not limited to, a corotron device, a scorotron device, a solid discharging element, a needle electrode device, a roller charger, and an electroconductive brush device, and any known system can be used.

Next, an image irradiator 12 irradiates the uniformly charged photoreceptor 10 to form a latent electrostatic image thereon. Typical luminous materials, for example, a fluorescent lamp, a tungsten lamp, a halogen lamp, a mercury lamp, a sodium lamp, a light emitting diode (LED), a semiconductor laser (LD), and electroluminescence (EL) can be used as the light source of the image irradiator 12. Various kinds of optical filters, for example, a sharp cut filter, a band-pass filter, a near infrared filter, a dichroic filter, a coherent filter, and a color conversion filter, can be used to irradiate an image bearing member with light having only a particular wavelength range.

Next, a development unit 13 develops and visualizes the latent electrostatic image formed on the photoreceptor 10. As the development method, there are a one-component developing method and a two-component development method using a dry toner and a wet-developing method using a wet toner. When the photoreceptor 10 is positively (or negatively) charged and irradiated, a positive (or negative) latent electrostatic image is formed on the photoreceptor 10. When the latent electrostatic image is developed with a negatively (or positively) charged toner (volt-detecting fine particles), a positive image is formed. When the latent electrostatic image is developed using a positively (or negatively) charged toner, a negative image is formed.

A transfer charger 16 transfers the toner image visualized on the photoreceptor 10 to a recording medium 15. In addition, the recording medium 15 is sent to the photoreceptor 10 via a registration roller 14. The transfer device can use an electrostatic transfer system using a transfer charger or a bias roller, a mechanical transfer system using an adhesive transfer method, a pressure transfer method, etc., and a magnetic transfer system. The charger described above can be used in the electrostatic transfer system.

A separation charger and a separation claw are used to separate the transfer medium 15 from the photoreceptor 10. Other separation methods that can be used are, for example, electrostatic sucking induction separation, side edge belt separation, front edge grip conveyance, and curvature separation. The charger can be used as the separation charger.

A discharging unit can be optionally used to remove the latent electrostatic image on the photoreceptor 10. As the discharging unit, a discharging lamp 18 or a discharging charger can be used. The irradiation light source and the charger described above can be used.

In addition, with regard to the processes that are conducted not in the vicinity of the photoreceptor 10, i.e., reading an original, sheet-feeding, fixing, and paper-discharging, known devices and methods in the art can be used.

The present disclosure provides an image forming apparatus using such an image forming device.

The image forming device may be fixed in and incorporated into a photocopier, a facsimile machine, or a printer or may form a process cartridge that is detachably attachable to the image forming apparatus.

### Process Cartridge

The process cartridge of the present disclosure is a device (part) including the image bearing member of the present disclosure and at least one device selected from the group consisting of other optional devices such as a charger, a development device, a transfer device, and a discharger and detachably attachable to an image forming apparatus.

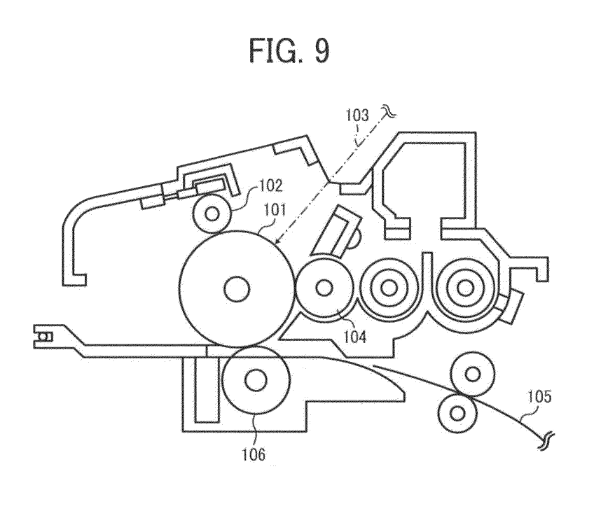

FIG. 9 is a schematic diagram illustrating an example of a process cartridge of the present disclosure.

The process cartridge of FIG. 9 includes a photoreceptor (image bearing member) 101 of the present disclosure, a charging device 102, a development device 104, and a transfer device 106. In FIG. 9, the numeral references 103 and 105 represent beams of light by an irradiator and a recording medium, respectively. A cleaner can be optionally provided.

Next, the image forming process by the process cartridge illustrated in FIG. 9 is described. The photoreceptor 101 is charged by the charger 102 and irradiated with the beams of light 103 by an irradiator while rotating clockwise to form a latent electrostatic image corresponding to the irradiation image on the surface of the photoreceptor 101.

This latent electrostatic image is developed by the development device 104 and the obtained visual image is transferred by a transfer device 106 to a recording medium 105 for printout. The surface of the photoreceptor 101 after image transfer is discharged by a discharging device to be ready for the next image forming process.

Since the image forming apparatus and the process cartridge of the present disclosure use the image bearing member having the surface protective layer having a strong abrasion resistance and an excellent toner releasability, they can continue producing fine and quality images for an extended period of time while preventing production of defective images ascribable to poor cleaning performance and can be used in an image forming apparatus having no cleaner.

The image bearing member of the present disclosure can be widely applied to, for example, a laser printer, a direct digital plate maker, a full color photocopier employing direct or indirect multi-color electrophotography, a full color laser printer, a CRT printer, an LED printer, a liquid crystal printer, a laser plate making, and a full color plain paper facsimile.

Having generally described (preferred embodiments of) this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but not limited thereto.

### Example 1

### Manufacturing of Image Bearing Member

A liquid application for an undercoating layer, a liquid application for a charge generating layer, and a liquid application for a charge transport layer having the following recipes are sequentially applied to an aluminum cylinder by dip-coating followed by drying to obtain an undercoating layer having a thickness of 3.5 μm, a charge generating layer having a thickness of 0.2 μm, and a charge transport layer having a thickness of 23 μm.

Liquid Application for Undercoating Layer

| | | |
|---|---|---|
| Alkyd resin (Beckozole 1307-60-EL, manufactured by | 6 | parts |
| Dainippon Ink and Chemicals, Inc.) | | |
| Melamine resin (SuperBeckamine G-821-60, manufactured | 4 | parts |
| by Dainippon Ink and Chemicals, Inc.) | | |
| Titanium Oxide | 40 | parts |
| Methylethylketone | 50 | parts |

Liquid Application for Charge Generating Layer

| | | |
|---|---|---|
| Bisazo pigment represented by the following Chemical Structure 2 | 2.5 | parts |
| 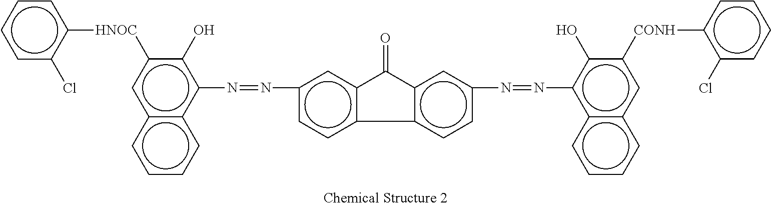 | | |
| Polyvinyl butyral {XYHL, manufactured by Union Carbide Corporation (UCC)} | 0.5 | parts |
| Cyclohexanone | 200 | parts |
| Methylethylketone | 80 | parts |

Liquid Application for Charge Transport Layer

| | | |
|---|---|---|
| Bisphenol Z type polycarbonate (PanLite TS-2050, | 10 | parts |
| manufactured by Teijin Chemicals Ltd.) | | |
| Charge transport material represented by | 7 | parts |
| the following Chemical Structure 3: | | |
| 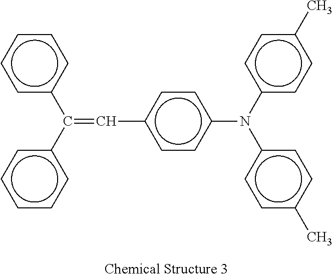 | | |
| Tetrahydrofuran | 100 | parts |
| Silicone oil (KF50-100CS, manufactured by | 0.01 | parts |
| Shin-Etsu Chemical Co., Ltd.): | | |

Next, using a liquid application for a surface protective layer having the following recipe (solid portion: 20% by weight) is spray-coated on the charge transport layer followed by drying at 160° C. for 60 minutes to form a surface protective layer having a thickness of 3 μm. Thus, the image bearing member 1 of Example 1 is manufactured.

Liquid Application for Surface Protective Layer

| | | |
|---|---|---|
| Resol type phenolic resin (SUMILITE ® RESIN | 4 | parts |
| PR-50404, 77% by weight solution, manufactured | | |
| by SUMITOMO BAKELITE CO., LTD.) | | |
| Methanol | 11.4 | parts |

Example 2

The image bearing member 2 is manufactured in the same manner as in Example 1 except that the thickness of the surface protective layer is changed to 2 μm.

### Example 3

The image bearing member 3 is manufactured in the same manner as in Example 1 except that, using a liquid application for a surface protective layer having the following recipe (solid portion: 20% by weight) is spray-coated followed by drying at 160° C. for 60 minutes to form a surface protective layer having a thickness of 5 μm.

Liquid Application for Surface Protective Layer

| | | |
|---|---|---|
| Resol type phenolic resin (SUMILITE ® RESIN | 4 | parts |
| PR-50404, 77% by weight solution, manufactured | | |
| by SUMITOMO BAKELITE CO., LTD.) | | |
| Filler (Electroconductive particulate CELNAX ® | 1.5 | parts |
| CX-Z210IP, 20% by weight solution, manufactured | | |
| by NISSAN CHEMICAL INDUSTRIES, LTD.) | | |
| Methanol | 11.4 | parts |

### Example 4

The image bearing member 4 is manufactured in the same manner as in Example 1 except that, using a liquid application for a surface protective layer having the following recipe (solid portion: 20% by weight) is spray-coated followed by drying at 160° C. for 60 minutes to form a surface protective layer having a thickness of 3 μm.

Liquid Application for Surface Protective Layer

| | | |
|---|---|---|
| Resol type phenolic resin (SUMILITE ® RESIN | 4 | parts |
| PR-50404, 77% by weight solution, manufactured | | |
| by SUMITOMO BAKELITE CO., LTD.) | | |
| Filler (Alumina filler, AA-03, manufactured | 0.3 | parts |
| by SUMITOTMO CHEMICAL CO., LTD.) | | |
| Methanol | 12.6 | parts |

### Comparative Example 1

The image bearing member 5 is manufactured in the same manner as in Example 1 except that the surface protective layer is dried at 130° C. for 60 minutes.

### Comparative Example 2

The image bearing member 6 is manufactured in the same manner as in Example 1 except that the surface protective layer is dried at 130° C. for 60 minutes and has a thickness of 1 μm.

### Example 5

The image bearing member 7 is manufactured in the same manner as in Example 1 except that the surface protective layer is dried at 175° C. for 60 minutes.

### Comparative Example 3

The image bearing member 8 is manufactured in the same manner as in Example 1 except that the surface protective layer is dried at 190° C. for 60 minutes.

### Comparative Example 4

The image bearing member 9 is manufactured in the same manner as in Example 1 except that the thickness of the surface protective layer is changed to 1 μm.

### Example 6

The image bearing member 10 is manufactured in the same manner as in Example 1 except that the thickness of the surface protective layer is changed to 6 μm.

### Comparative Example 5

The image bearing member 11 is manufactured in the same manner as in Example 1 except that, using a liquid application for a surface protective layer having the following recipe (solid portion: 5% by weight) is spray-coated followed by drying at 160° C. for 60 minutes to form a surface protective layer having a thickness of 3 μm.

Liquid Application for Surface Protective Layer

| | | |
|---|---|---|
| Resol type phenolic resin (SUMILITE ® RESIN | 4 | parts |
| PR-50404, 77% by weight solution, manufactured | | |
| by SUMITOMO BAKELITE CO., LTD.) | | |
| Methanol | 57.6 | parts |

### Comparative Example 6

The image bearing member 12 is manufactured in the same manner as in Example 1 except that, using a liquid application for a surface protective layer having the following recipe (solid portion: 30% by weight) is spray-coated followed by drying at 160° C. for 60 minutes to form a surface protective layer having a thickness of 3 μm.

Liquid Application for Surface Protective Layer

| | | |
|---|---|---|
| Resol type phenolic resin (SUMILITE ® RESIN | 4 | parts |
| PR-50404, 77% by weight solution, manufactured | | |
| by SUMITOMO BAKELITE CO., LTD.) | | |
| Methanol | 6.25 | parts |

### Comparative Example 7

The image bearing member 13 is manufactured in the same manner as in Example 1 except that no surface protective layer is provided.

Measure an area of 10 μm×10 μm of the surface of the image bearing members 1 to 13 manufactured as described above by an intermolecular force microscope under the following conditions. The results are shown in Table 1.
Analyzer: atomic force microscope system MFP-3D-SA, manufactured by Asylum Technology Co., Ltd.
Cantilever: OMCL-AC240TS, [Si probe, resonance frequency 70 kHz (Typ.), constant of spring: 1.8 N/m (Typ.)]
Measuring mode: AC mode (Tapping mode)
Measuring Conditions
   Vibration frequency: 75.093 kHz
   Scan rate: 0.5 Hz
   Scan points: 256×256

TABLE 1

| | | Protective | Protective | Drying | |
|---|---|---|---|---|---|
| | | surface | surface layer | temper- | Solid |
| | | layer | thickness | ature | portion |
| | | composition | (μm) | (° C.) | (%) |
| Example 1 | Image | Phenolic | 3 | 160 | 20 |
| | bearing | resin | | | |
| | member 1 | | | | |
| Example 2 | Image | Phenolic | 2 | 160 | 20 |
| | bearing | resin | | | |
| | member 2 | | | | |
| Example 3 | Image | Phenolic | 5 | 160 | 20 |
| | bearing | resin | | | |
| | member 3 | Filler | | | |
| Example 4 | Image | Phenolic | 3 | 160 | 20 |
| | bearing | resin | | | |
| | member 4 | Filler | | | |
| Compar- | Image | Phenolic | 3 | 130 | 20 |
| ative | bearing | resin | | | |
| Example 1 | member 5 | | | | |
| Compar- | Image | Phenolic | 1 | 130 | 20 |
| ative | bearing | resin | | | |
| Example 2 | member 6 | | | | |
| Example 5 | Image | Phenolic | 3 | 175 | 20 |
| | bearing | resin | | | |
| | member 7 | | | | |
| Compar- | Image | Phenolic | 3 | 190 | 20 |
| ative | bearing | resin | | | |
| Example 3 | member 8 | | | | |
| Compar- | Image | Phenolic | 1 | 160 | 20 |
| ative | bearing | resin | | | |
| Example 4 | member 9 | | | | |
| Example 6 | Image | Phenolic | 6 | 160 | 20 |
| | bearing | resin | | | |
| | member 10 | | | | |
| Compar- | Image | Phenolic | 3 | 160 | 5 |
| ative | bearing | resin | | | |
| Example 5 | member 11 | | | | |
| Compar- | Image | Phenolic | 3 | 160 | 30 |
| ative | bearing | resin | | | |
| Example 6 | member 12 | | | | |
| Compar- | Image | No Pro- | — | — | — |
| ative | bearing | tective | | | |
| Example 7 | member 13 | surface | | | |
| | | layer | | | |

| | Concavo shape | | |
|---|---|---|---|
| | Maximum | Maximum | Closest distance |
| | diameter | depth | between concave |
| | (μm) | (nm) | portions (μm) |
| Example 1 | 1.8 | 34 | 2.3 |
| Example 2 | 2.6 | 11 | 2.8 |
| Example 3 | 2.1 | 34 | 2.2 |
| Example 4 | 2.0 | 32 | 2.5 |
| Comparative | 5.2 | 240 | 6.0 |
| Example 1 | | | |
| Comparative | 4.1 | 36 | 2.8 |
| Example 2 | | | |
| Example 5 | 1.4 | 35 | 2.5 |
| Comparative | 0.8 | 34 | 2.1 |
| Example 3 | | | |
| Comparative | 1.8 | 4 | 2.5 |
| Example 4 | | | |
| Example 6 | 2.1 | 45 | 2.3 |
| Comparative | 2.8 | 66 | 2.7 |
| Example 5 | | | |
| Comparative | 2.7 | 11 | 4.5 |
| Example 6 | | | |

| | |
|---|---|
| Comparative | No distinctive concave portions seen |
| Example 7 | |

Next, conduct a machine-running test for a run length of 20,000 sheets by using a machine remodeled based on imagio MP 9001, manufactured by RICOH CO., LTD. The manufactured image bearing member is attached to a process cartridge, from which the cleaner (cleaning brush and cleaning blade) is removed. The process cartridge is attached to the machine. Measure the transfer rate and evaluated the quality of produced images as follows: The results are shown in Table 2.

### Transfer Rate

Conduct evaluation before and after outputting the 20,000th sheet as follows: Output a black solid image having a size of 2 cm² and stop the machine before the toner is transferred to a transfer sheet to obtain the amount of the toner on the image bearing member. Thereafter, output the black solid image having a size of 2 cm² again and stop the machine immediately after the toner is transferred to a transfer sheet to obtain the amount of the toner on the image bearing member. Calculate the transfer rate of the remaining toner on the image bearing member from the measuring results.

### Image Evaluation

After printing the image on 20,000 sheets, print an image with a white pattern, a black pattern, and a half tone pattern on two sheets of A3 size to check whether defective images are produced.

TABLE 2

| | | Transfer rate (%) | | |
|---|---|---|---|---|
| | Image bearing | | After 20,000 | Image |
| | member | Initial | sheets | evaluation |
| Example 1 | Image bearing | 98 | 97 | Good |
| | member 1 | | | |
| Example 2 | Image bearing | 98 | 97 | Good |
| | member 2 | | | |
| Example 3 | Image bearing | 98 | 98 | Good |
| | member 3 | | | |
| Example 4 | Image bearing | 98 | 98 | Good |
| | member 4 | | | |
| Example 5 | Image bearing | 98 | 97 | Slightly light |
| | member 7 | | | image density |
| | | | | for black pattern |
| | | | | and half tone |
| Example 6 | Image bearing | 96 | 96 | Slightly light |
| | member 10 | | | image density |
| | | | | for black pattern |
| | | | | and half tone |
| Comparative | Image bearing | 87 | 86 | Vertical streaks |
| Example 1 | member 5 | | | observed locally |
| | | | | for half pattern |
| Comparative | Image bearing | 83 | 82 | Vertical streaks |
| Example 2 | member 6 | | | observed locally |
| | | | | for half pattern |
| Comparative | Image bearing | 85 | 84 | Vertical streaks |
| Example 3 | member 8 | | | observed entirely |
| | | | | for white pattern |
| | | | | and half pattern |
| Comparative | Image bearing | 83 | 82 | Vertical streaks |
| Example 4 | member 9 | | | observed locally |
| | | | | for half pattern |
| Comparative | Image bearing | 90 | 89 | Vertical streaks |
| Example 5 | member 11 | | | observed locally |
| | | | | for half pattern |
| Comparative | Image bearing | 82 | 81 | Vertical streaks |
| Example 6 | member 12 | | | observed locally |
| | | | | for half pattern |
| Comparative | Image bearing | 82 | 80 | Vertical streaks |
| Example 7 | member 13 | | | observed entirely |
| | | | | for white pattern |
| | | | | and half pattern |

As seen in the results, the forming apparatus using the image bearing member having the surface protective layer having multiple concave structures with a maximum diameter of from 1 μm to 3 μm and a maximum depth of 10 nm to 15 nm while any of the concave structures has at least one other concave structure within 3 μm thereof produces quality images without defection.

What is claimed is:

1. An image bearing member comprising:
a substrate;
a photosensitive layer overlying the substrate; and
a surface protective layer overlying the photosensitive layer and having a surface comprising multiple concave structures with a maximum diameter of from 1 μm to 3 μm and a maximum depth of from 10 nm to 50 nm,
any one of the concave structures having at least one other concave structure within 3 μm thereof.

2. The image bearing member according to claim 1, wherein the surface protective layer comprises a resol type phenolic resin.

3. The image bearing member according to claim 1, wherein the surface protective layer comprises a filler.

4. The image bearing member according to claim 1, wherein the surface protective layer has a thickness of from 2 μm to 5 μm.

5. A process cartridge comprising:
the image bearing member of claim 1; and
at least one device selected from the group consisting of a charger, a development device, a transfer device, and a discharging device,
wherein the process cartridge is detachably attachable to an image forming apparatus.

6. An image forming apparatus comprising:
the image bearing member of claim 1;
a charger to charge a surface of the image bearing member;
an irradiator to irradiate the surface of the image bearing member with beams of light to form a latent electrostatic image on the surface of the image bearing member;
a development device to develop the latent electrostatic image with toner to form a visual image;
a transfer device to transfer the visual image onto a recording medium; and
a fixing device to fix the visual image on the recording medium.

7. The image forming apparatus according to claim 6, lacking a cleaner to remove toner remaining on the image bearing member after transferring the latent electrostatic image onto the recording medium.
